(19) United States
(12) Patent Application Publication
(10) Pub. No.: US 2014/0355807 A1
(43) Pub. Date: Dec. 4, 2014

(54) Protective Head Covering Audio System

(71) Applicant: Sean McDowell, Wasilla, AK (US)

(72) Inventor: Sean McDowell, Wasilla, AK (US)

(21) Appl. No.: 14/291,778

(22) Filed: May 30, 2014

Related U.S. Application Data
(60) Provisional application No. 61/829,643, filed on May 31, 2013.

(51) Int. Cl. H04R 1/02

(52) U.S. Cl. CPC H04R 1/02
USPC 381/334

(57) ABSTRACT

A head covering having integral, internal microphones is provided. The present invention is adapted to removably hold a portable audio device within its interior and is further adapted to play music therefrom. The portable audio device is removably held within a sleeve that has an internal audio connector, which is positioned so that the audio connector automatically engages with the portable audio device's audio port when the portable audio device is placed therein. The user can then play audio, which is then played over the present invention's internal microphones and can be enjoyed by the user. In a preferred embodiment of the present invention, the head covering is a hard hat.

### CROSS REFERENCE TO RELATED APPLICATION

This application claims the benefit of U.S. Provisional Application No. 61/829,643 filed on May 31, 2013. The above identified patent application is herein incorporated by reference in its entirety to provide continuity of disclosure.

### BACKGROUND OF THE INVENTION

1. Field of the Invention

The present invention relates to head coverings. More specifically, the present invention relates to protective head coverings having internal microphones and that is connectable to a portable audio device that is adapted to store and play music.

Many individuals enjoy listening to music while working or performing other tasks. However, using a stereo to listen to music requires that everyone in the vicinity agree on the type of music to be played. Furthermore, if individuals' work takes them away from the area immediately surrounding the stereo, they will not be able to hear the music therefrom. Many individuals instead choose to listen to music from a portable audio device using headphones, but headphones have cords that can get snagged or otherwise interfere with an individual's work. Therefore, there is a need in the prior art for a device that provides users with a means to listen to music or other audio in a manner that does not interfere their ability to work properly and has consistent sound quality and volume.

Hats, helmets, and other such head coverings having integrated audio systems or means for holding portable audio devices and their various associated accessories are known in the prior art. These devices generally include extendable and retractable integrated earphones that can be connected to a portable audio device or a pocket, recess, or other type of holding means for securing a portable audio device against the exterior surface of the head covering. None of these devices comprise a means for holding a portable audio device within the interior portion of the head covering and none of these devices utilizes integrated microphones that are directly attached to the portable audio device holding means.

The present invention comprises a protective head covering, such as a hard hat, which has a pocket or holder adapted to hold a portable audio device, an audio jack disposed within the interior of the holder that is adapted to automatically engage with the audio port of the portable audio device when it is inserted therein, and microphones disposed on the holder that are electrically connected to the audio jack and are adapted to transmit electrical audio signals therebetween. The holder is preferably removably affixed to the interior surface of head protective head covering so that the protective head covering protects it from damage. The present invention provides individuals with excellent sound quality in a cord-free and convenient manner.

2. Description of the Prior Art

Devices have been disclosed in the prior art that relate to protective head coverings that are adapted to hold a portable audio device. These include devices that have been patented and published in patent application publications. These devices generally relate to head coverings having attachment clips or sleeves disposed along the exterior surface of the head coverings. The following is a list of devices deemed most relevant to the present disclosure, which are herein described for the purposes of highlighting and differentiating the unique aspects of the present invention, and further highlighting the drawbacks existing in the prior art.

One such device includes U.S. Pat. No. 5,142,700 to Reed, which discloses a protective helmet having an integral transceiver. Reed comprises an outer shell composed of impact-resistant material, an inner protective lining, and an integral, self-contained system for two-way wireless communication, including microphones. The present invention also comprises an outer shell composed of impact-resistant material, an inner protective lining, and microphones, however it also comprises a means for removably mounting a portable audio device therein.

Another such device is U.S. Pat. No. 5,581,821 to Nakano, which discloses a construction helmet having integral, retractable earplugs. The present invention comprises a sleeve for removably holding a portable audio in place within the interior volume of the protective head covering and utilizes microphone, unlike Nakano, which utilizes earplugs. Nakano is designed to prevent damage to users' eardrums, whereas the present invention is adapted to provide users with a means for listening to music or other audio.

U.S. Pat. No. 8,245,326 to Tolve discloses a rigid helmet that comprises an mp3 holder disposed on the back portion of the helmet that is connected to an internal earphone assembly. Unlike Tolve, the present invention comprises a holder that is removably affixed within the interior of the protective head covering, rather than to the exterior, and further comprises a microphone assembly, rather than an earphone assembly. The design of the present invention is more preferable because it protects the portable audio device from damage because it is secured within the interior of the helmet, whereas the Tolve device leaves a portable audio device free to be damaged since it is affixed to the exterior portion of the helmet.

U.S. Pat. No. 8,316,467 to Foust et al. discloses a head covering that has pockets for holding portable audio devices and their various accessories. One embodiment of the present invention also utilizes a pocket or a sleeve to removably secure a portable audio device; however, the sleeve or pocket of the present invention further comprises an audio jack that is adapted to engage with the audio port of a portable audio device inserted therein and a built-in microphone system.

Another device, U.S. Patent Application Publication No. 2006/0185062 to Peng et al., discloses a head-mountable mp3 player comprising an article adapted to be worn on the head of a user, an integral mp3 module, and at least one earphone. The present invention comprises a means for holding a portable audio device, rather than an integral audio playing device. Therefore, the present invention can be utilized with a portable audio device already owned by an individual.

Finally, U.S. Patent Application Publication No. 2009/0208040 to Planansky discloses a head-worn article that is adapted to hold a portable audio devices and a pair of earphones via a clip disposed along the edge of the head-worn article. The present invention comprises a holder removably disposed within the interior of the head covering, rather than a clip disposed along its peripheral edge, and further comprises a pair of audio microphones that are integrally affixed to the holder.

The present invention comprises a head covering, a portable audio device holder removably affixed within the interior of the head covering, an audio jack disposed within the interior of the holder that is adapted to engage with the audio port of a portable audio device placed therein, and at least one integral microphone. The present invention is designed to hold and play audio from a portable audio device in a convenient and hands-free manner so that users can listen to music without any interference from cords and without having to accommodate other individual's listening preferences. The head covering comprises hardhats, helmets, and other such protective head coverings. It substantially diverges in design elements from the prior art and consequently it is clear that there is a need in the art for an improvement to existing head coverings adapted to hold portable audio devices. In this regard the instant invention substantially fulfills these needs.

### SUMMARY OF THE INVENTION

In view of the foregoing disadvantages inherent in the known types of protective head covering audio systems now present in the prior art, the present invention provides a new protective head covering audio system wherein the same can be utilized for providing convenience for the user when working, riding a motorcycle, or taking part in any other activity for which a protective head covering is necessary.

It is therefore an object of the present invention to provide a new and improved head covering audio system device that has all of the advantages of the prior art and none of the disadvantages.

It is another object of the present invention to provide a head covering audio system device that is adapted to removably hold a portable audio device within the interior volume of the head covering.

Another object of the present invention is to provide a head covering audio system device that comprises an outer shell constructed from rigid, impact-resistant materials.

Another object of the present invention is to provide a head covering audio system device that comprises an audio jack disposed within the interior of the holder that is adapted to automatically engage with the port of a portable audio device when the portable audio device is placed therein.

Yet another object of the present invention is to provide a head covering audio system device that does not utilize a power source to play music or other audio.

Still yet another object of the present invention is to provide a head covering audio system device that is usable with a variety of different portable audio devices.

Still yet another object of the present invention is to provide a head covering audio system device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the portable audio device holder portion of the present invention and a portable audio device, which is removably placeable therein.

FIG. 2 shows a cutaway view of the present invention with the portable audio device holder secured to the interior surface of the head covering.

### DETAILED DESCRIPTION OF THE INVENTION

Reference is made herein to the attached drawings. Like reference numerals are used throughout the drawings to depict like or similar elements of the protective head covering audio system device. For the purposes of presenting a brief and clear description of the present invention, the preferred embodiment will be discussed as a hardhat. The figures are intended for representative purposes only and should not be considered to be limiting in any respect.

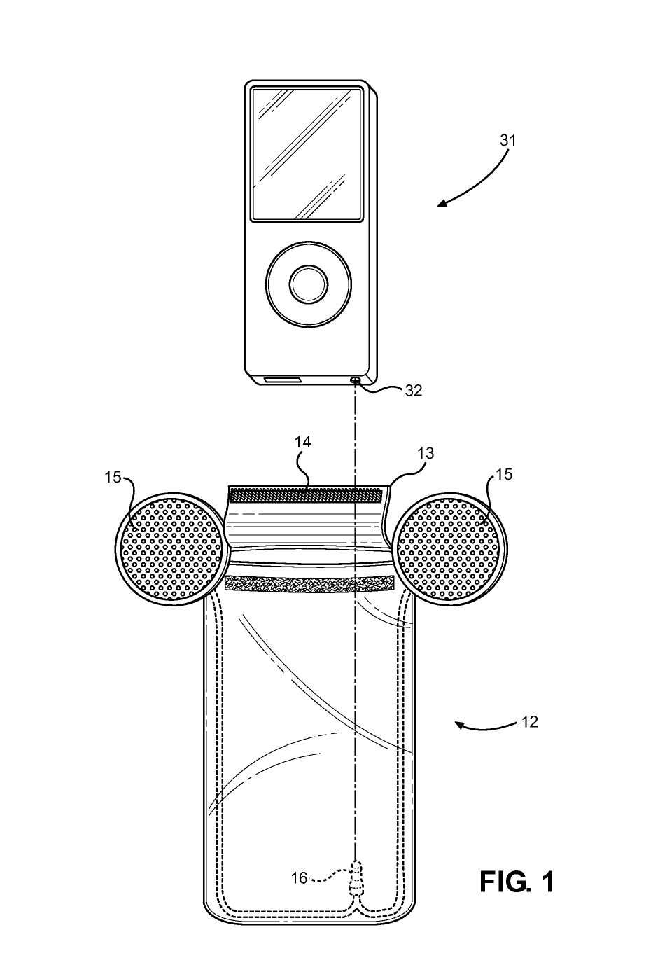

Referring now to FIG. 1, there is shown a perspective view of the portable audio device holder portion of the present invention and a portable audio device, which is removably placeable therein. The present invention comprises a head covering and a portable audio device holder 12 that is removably affixable to the interior surface of the head covering. The holder 12 comprises pocket or sleeve that has an internal volume adapted to accept a portable audio device 31, an audio connector 16 extending from the interior surface of the holder 12 into the holder's 12 interior volume, at least one microphone 15, and the necessary circuitry to connect the audio connector 16 to the microphones 15 and relay electrical audio signals therebetween. The holder 12 further comprises a flap 13 and a connector 14 that is adapted to removably secure a portable audio device 31 within the interior volume of the holder 12 so that it does not slip or fall therefrom when in use. Portable audio devices 31 include mp3 players, smart phones, and other such mobile electronic devices that are adapted to play music or other audio.

The male audio connector 16 extends from the interior surface of the portable audio device holder 12 and is positioned so that it automatically engages with the complementary female audio port 32 disposed on the portable audio device 31 when the portable audio device 31 is placed within the holder 12. However, no claim is made as to the specific position of the audio connector 16 as it may be in different positions in different embodiments of the present invention in order to accommodate different models, types, and designs of portable audio devices 31. The audio connector 16 comprises any type of audio jack known in the prior art and no claim is made as to a specific type utilized by the present invention.

The microphones 15 are integrally affixed to the exterior surface of the holder 12 and are electrically connected to the audio connector 16. When a portable audio device 31 is placed within the holder 12, the audio connector 16 engages with the complementary audio port 32 and then the audio connector 16 electrically relays the audio signals therefrom to the microphones 15, which then transmit the audio. The microphones function similarly to conventional earphones in that they do not require a power source; however, they are not adapted to be placed within a user's ear or ear canal and instead are adapted to emit audio within the interior volume of the head covering for the user's listening enjoyment. The microphones 15 further comprise an audio amplifier to increase the volume of the audio being transmitted from the portable audio device 31.

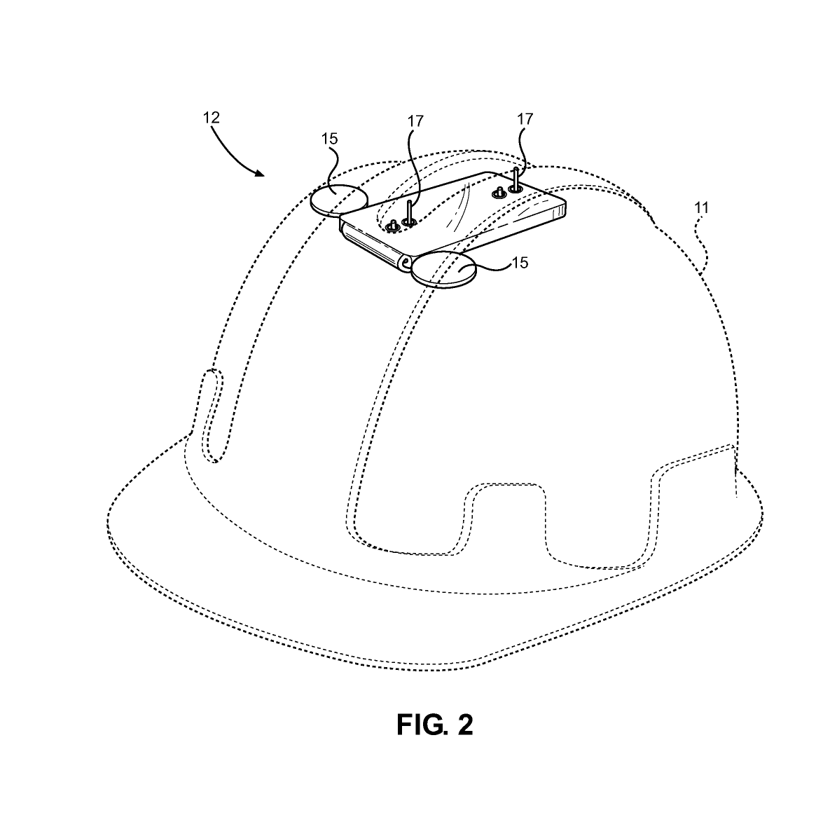

Referring now to FIG. 2, there is shown a cutaway view of the present invention with the portable audio device holder secured to the interior surface of the head covering. The holder 12 is removably affixed to the interior surface of the head covering 11 via fasteners 17. In the depicted embodiment of the present invention, the fasteners 17 comprise hooks that are removably inserted through complementary apertures disposed on the back surface of the holder; however, no claim is made as to a specific type or configuration of fastener utilized by the present invention. Other fasteners may include hook-and-loop fastener material, adhesive, magnets, and any other such type of connection.

The head covering 11 is preferably composed of rigid, durable, and protective materials in order to protect the user's head and the portable audio device stored thereunder. In the depicted embodiment of the present invention, the head covering 11 is a hardhat. However, the head covering 11 further comprises bike helmets, motorcycle helmets, baseball hats, and any other such head-worn articles. The head covering 11 is preferably adapted to sit on the user's head so that there is a space between the top portion of the heading covering 11 and the user's head. This both creates space for the holder 12 and the portable audio device and protects the user's head from impacts. For example, conventional hardhats generally comprise a protective out layer and an inner suspension that holds the protective outer layer a given distance above the user's head. Furthermore, the curvature of the interior of the heading cover 11 acts as a further means for amplifying sound because the sound emitted from the microphones 15 bounces between the walls of the head covering 11 multiple times.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A head covering, comprising:
a portable audio device holder having an exterior surface, an interior surface, and an interior volume;
an audio connector extending from said portable audio device interior surface;
at least one microphone affixed to said portable audio device holder;
wherein said portable audio device holder is affixed to said head covering interior surface;
wherein said audio connector is adapted to relay electrical audio signals to said at least one microphone.

2) The head covering of claim 1, wherein said portable audio device holder is removably affixed to said head covering interior surface.

3) The head covering of claim 1, wherein said head covering is composed of rigid materials adapted to absorb impacts.

4) The head covering of claim 1, wherein said head covering is a hardhat.

5) The head covering of claim 1, wherein said head covering is a helmet.

6) The head covering of claim 1, further comprising a flap and a connector adapted to removably secure a portable audio device within said portable audio device holder.

7) The head covering of claim 1, wherein said audio connector is adapted to automatically engage a complementary audio port of a portable electronic device inserted into said portable audio device holder.

8) The head covering of claim 7, wherein said portable audio device holder is removably affixed to said head covering interior surface.

9) The head covering of claim 7, wherein said head covering is composed of rigid materials adapted to absorb impacts.

10) The head covering of claim 7, wherein said head covering is a hardhat.

11) The head covering of claim 7, wherein said head covering is a helmet.

12) The head covering of claim 7, further comprising a flap and a connector adapted to removably secure a portable audio device within said portable audio device holder.
